(19) United States
(12) Patent Application Publication
(10) Pub. No.: US 2008/0291571 A1
(43) Pub. Date: Nov. 27, 2008

(54) MAGNETIC HEAD AND INFORMATION STORAGE DEVICE

(75) Inventors: Yuko Miyake, Kawasaki (JP); Masaaki Matsuoka, Kawasaki (JP); Mitsuru Otagiri, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/112,741

(22) Filed: Apr. 30, 2008

(30) Foreign Application Priority Data
May 22, 2007 (JP) 2007-135360
Feb. 21, 2008 (JP) 2008-039541

(51) Int. Cl. G11B 5/17

(52) U.S. Cl. 360/123.01

(57) ABSTRACT

A magnetic head of the present invention includes a magnetic pole that faces a surface of a recording medium, moves relative to the surface in a direction along the surface, and produces a line of magnetic force intersecting the surface of the recording medium; and a coil that excites the magnetic pole, wherein the magnetic pole includes a laminate with a coercivity of 800 A/m or less, the laminate including two or more layers stacked in a direction along the movement relative to the surface of the recording medium, the two or more layers including a first magnetic layer located at a frontmost position of the movement, and a second magnetic layer located at a rearmost position of the movement, the second magnetic layer having a saturation magnetic flux density higher than a saturation magnetic flux density of the first magnetic layer.

### BACKGROUND OF THE INVENTION

1. Field of the Invention

The present invention relates to a magnetic head that applies a magnetic field to a recording medium, and an information storage device that accesses a recording medium for information storage and retrieval using a magnetic field.

2. Description of the Related Art

With the development of the information society, the amount of information has been increasing. For responding to this information amount increase, the development of information recording systems and information storage devices with a dramatically-high recording density has been awaited. In particular, magnetic disks in which information is accessed via a magnetic field has gained attention as an information-rewritable, high-density recording medium, and has been actively studied and developed for further enhancing their recording densities.

As a magnetic recording system for recording information on a magnetic disk, in-plane recording in which a recording medium is magnetized in a direction along its surface (in-plane direction) has been widely used, but in recent years, perpendicular recording in which a recording medium is magnetized in a direction perpendicular to its surface has been actively developed. The perpendicular recording provides advantages in that the recording density (line recording density) in the circumferential direction of the tracks can be enhanced and the failures of recorded information being destructed due to heat fluctuation can be reduced, and it is expected that this perpendicular recording will be widely employed instead of the conventional in-plane recording.

FIG. 1 is a diagram for explaining the operation principle of perpendicular recording.

A magnetic head 10, which is shown in FIG. 1, includes thin-film coils 13 that generate a magnetic field according to information, a main magnetic pole 11 that produces a magnetic flux according to the magnetic field generated by the thin-film coils 13, and an auxiliary magnetic pole 12 that picks up the magnetic flux produced by the main magnetic pole 11 and feeds it back to the thin-film coils 13 and the main magnetic pole 11, and further includes a reproducing head 14 that detects a magnetic field by means of a reproducing element 14a to read information recorded on a magnetic disk 1.

Also, the magnetic disk 1 has a recording layer 1A in which information is recorded, and a soft magnetic layer 1B formed of a soft magnetic material, which are deposited on a substrate 1C. Upon this magnetic disk 1 being rotationally driven in an arrow R direction, the magnetic head 10 relatively moves on the magnetic disk 1 in an arrow R′ direction, which is opposite to the arrow R direction.

During information recording, an electric recording signal is input to the thin-film coils 13, and thereby a magnetic field in a direction according to information is generated from the thin-film coils 13. The generated magnetic field is supplied to the main magnetic pole 11, and a magnetic flux according to the magnetic pole is generated from the main magnetic pole 11. This magnetic flux is applied to the magnetic disk 1, thereby passing through a soft magnetic layer 1B of the magnetic disk 1, and then the magnetic flux is diffused and returns to the auxiliary magnetic pole 12, and is supplied to the thin-film coils 13 and the main magnetic pole 11. The flow of the magnetic flux collected in a letter U-like magnetic path via the soft magnetic layer 1B forms a recording magnetic field and the recording layer 1A is magnetized in a direction perpendicular to its surface, thereby information being recorded.

Known problems relating to the perpendicular recording magnetic head 10 shown in FIG. 1 are, for example, pole erasure in which remanent magnetization remaining in the main magnetic pole 11 leaks and is thereby applied to the magnetic disk 1, resulting in erasure of information previously recorded in the magnetic disk 1, and side erasure in which a skew of the magnetic head destructs information recorded in an adjacent track. Since the magnetic head 10 relatively moves on the magnetic disk 1 in the arrow R′ direction, upon the occurrence of pole erasure or side erasure, a broad range of information recorded in the magnetic disk 1 may be erased, and even servo information, which indicates, for example, the positions on the magnetic disk 1, may be erased, making it impossible to control the position of the magnetic head 10.

On this issue, a method in which the main magnetic pole of a magnetic head is made from, for example, an FeNi alloy, which exhibits a pole erasure preventing effect, is known. However, this FeNi alloy has a lower saturation magnetic flux density compared to, for example, an FeCo alloy, which has conventionally been used as a material for a main magnetic pole, causing a problem in that the recording density may be lowered.

As techniques for preventing pole erasure and achieving a high recording density, Japanese Patent Application Publication No. 2004-281023 discloses a technique that employs a main magnetic pole formed of plural ferromagnetic materials and non-magnetic materials alternately deposited in a magnetic head movement direction R′, and Japanese Patent Application Publication No. 2003-242608 discloses a technique for forming a main magnetic pole having a surface facing a magnetic disk, the width of the surface becoming narrower toward the inflow side of the magnetic disk (the front of the magnetic head moving direction R′), and becoming wider toward the outflow side of the magnetic disk (the rear of the magnetic head movement direction R′). According to the technique disclosed in Japanese Patent Application Publication No. 2004-281023, two ferromagnetic layers formed of ferromagnetic materials faces via a non-magnetic layer formed of a non-magnetic material, and their magnetization directions are opposite to each other, thereby making it possible to reduce remanent magnetization, and according to the technique disclosed in Japanese Patent Application Publication No. 2003-242608, a magnetic flux can efficiently be concentrated at the tip of the main magnetic pole, thereby making it possible to enhance the recording density. Accordingly, when the techniques described in Japanese Patent Application Publication No. 2004-281023 and 2003-242608 are employed in combination, it can be considered possible to achieve both pole erasure prevention and a high recording density.

However, the technique disclosed in Japanese Patent Application Publication No. 2004-281023 provides only a fairly limited number of combinations of ferromagnetic materials (e.g., FeCo) and non-magnetic materials (e.g., Ru) constituting a main magnetic pole. For example, when a main magnetic pole is formed of a combination of FeCo and Ru, plating, favorable in cost efficiency and mass productivity, cannot be used for a method for depositing these, and the method will substantially be limited to sputtering, causing a problem in that the manufacture costs will rise. Also, even when the techniques disclosed in Japanese Patent Application Publication Nos. 2004-281023 and 2003-242608, there is a problem in that side erasure cannot sufficiently be prevented.

The present invention has been made in view of the above circumstances and provides a magnetic head and an information storage device capable of achieving both pole erasure and side erasure prevention, and a high recording density, while curbing a rise in manufacture costs.

### SUMMARY OF THE INVENTION

A basic feature of a magnetic head according to one aspect of the present invention includes: a magnetic pole that faces a surface of a recording medium, moves relative to the surface in a direction along the surface, and produces a line of magnetic force intersecting the surface of the recording medium; and a coil that excites the magnetic pole, wherein the magnetic pole includes a laminate with a coercivity of 800 A/m or less, the laminate including two or more layers stacked in a direction along the movement relative to the surface of the recording medium, the two or more layers including a first magnetic layer located at a frontmost position of the movement, and a second magnetic layer located at a rearmost position of the movement, the second magnetic layer having a saturation magnetic flux density higher than a saturation magnetic flux density of the first magnetic layer.

It is known that pole erasure is highly correlated with the coercivity of a magnetic pole, and in order to prevent pole erasure, it is necessary to restrain the coercivity of the magnetic pole to around no more than 800 A/m. Meanwhile, in order to enhance the recording density of a magnetic head, it is necessary that a magnetic pole have a high saturation magnetic flux density.

According to this basic feature of the magnetic head, the coercivity of the magnetic pole is 800 A/m or less, ensuring reliable prevention of pole erasure. Also, the frontmost part of the magnetic pole where side erasure easily occurs and there is only a small impact on the O/W (overwrite) performance is formed of the first magnetic layer with a low saturation magnetic flux density, and the rearmost part of the magnetic pole where there is a large impact on the O/W (overwrite) property is formed of the second magnetic layer with a high saturation magnetic flux density, so side erasure can effectively be prevented and the saturation magnetic flux density of the magnetic pole can be enhanced.

Furthermore, an additional feature of the magnetic head, in which the first magnetic layer has a composition of Ni₁₀₀₋ₓFeₓ (15≦x wt %), and the second magnetic layer has a composition of FeₓCo₁₀₀₋ₓ (65≦x≦75 wt %), is preferable.

It is known that vertical anisotropy occurs in a material having a composition range of Ni₁₀₀₋ₓFeₓ (15>x wt %). A magnetic layer having vertical anisotropy has a larger coercivity compared to a magnetic layer having in-plane anisotropy, and in addition, the coercivity may increase due to thermal stress during processing, causing a problem in that pole erasure easily occurs. According to this preferable embodiment, since the first magnetic layer having a composition of Ni₁₀₀₋ₓFeₓ (15≦x wt %) has in-plane anisotropy, the coercivity can sufficiently be lowered, making it possible to prevent pole erasure. Also, since the second magnetic layer has a composition of FeₓCo₁₀₀₋ₓ (65≦x≦75 wt %), the saturation magnetic flux density of the magnetic pole can be maintained to be sufficiently high (around 2.3 T or more).

An additional feature of the aforementioned magnetic head, in which the first magnetic layer has a composition of Ni₁₀₀₋ₓFeₓ (18≦x≦70 wt %), and the second magnetic layer has a composition of FeₓCo₁₀₀₋ₓ (65≦x≦75 wt %), is further preferable.

As a result of employing the first magnetic layer having a composition range of Ni₁₀₀₋ₓFeₓ (18≦x≦70 wt %), the coercivity can efficiently be lowered and reliable pole erasure prevention can be ensured.

Also, in an NiFe alloy, when the percentage of Fe is decreased, the saturation magnetic flux density value also decrease in line with that, and accordingly, if the first magnetic layer has a composition range of Ni₁₀₀₋ₓFeₓ (18≦x≦70 wt %), the saturation magnetic flux density of the entire magnetic pole is also lowered, which may cause O/W performance deterioration. However, at this time, it has been understood that although the coercivity becomes lower as the percentage of the first magnetic layer relative to the magnetic pole is increased, when the percentage of the first magnetic layer exceeds a predetermined value (approximately 40%), the coercivity levels off. Accordingly, both pole erasure prevention and O/W performance enhancement can be achieved by restraining the percentage of the first magnetic layer having a composition range of Ni₁₀₀₋ₓFeₓ (18≦x≦70 wt %), and enhancing the percentage of the second magnetic layer having a large impact on the saturation magnetic flux density of the entire magnetic pole.

Furthermore, an additional feature of the aforementioned magnetic head, in which the first magnetic layer has a composition of CoₓNi_{y}Fe_{z} (x+y+z=100, 0<y≦10, 0<x≦33 wt %), and the second magnetic layer has a composition of FeₓCo₁₀₀₋ₓ (65≦x≦75 wt %), is preferable.

As a result of the first magnetic layer having a composition of COₓNi_{y}Fe_{z} (x+y+z=100, 0<y≦ 10, 0<x≦33 wt %), the coercivity of the magnetic pole can be restrained to 800 A/m or less and pole erasure can reliably be prevented.

An additional feature of the aforementioned magnetic head, in which the first magnetic layer has a composition of FeₓCo₁₀₀₋ₓ (75≦x wt %), and the second magnetic layer has a composition of FeₓCo₁₀₀₋ₓ (65≦x≦75 wt %), is preferable.

As a result of the first magnetic layer having a composition of FeₓCo₁₀₀₋ₓ (75≦x wt %), the magnetostriction can be restrained, and the coercivity can be lowered, thereby preventing pole erasure.

Furthermore, an additional feature of the aforementioned magnetic head, in which the first magnetic layer has a composition of CoₓNi_{y}Fe_{z} (x+y+z=100, 64≦x≦68, 15≦z≦20 wt %), and the second magnetic layer has a composition of FeₓCo₁₀₀₋ₓ (65≦x≦75 wt %), is preferable.

When the first magnetic layer has a composition of CoₓNi_{y}Fe_{z} (x+y+z=100, 60≦x≦80, 10≦z≦20 wt %), pole erasure can also efficiently be prevented.

Furthermore, an additional feature of the aforementioned magnetic head, in which the first magnetic layer and the second magnetic layer of the magnetic pole are formed by plating, is preferable.

In the basic feature of the magnetic head, as materials for forming the first magnetic layer and the second magnetic layer, a combination of magnetic materials with saturation magnetic flux densities that are different from each other may be employed, and both of them may also be ferromagnetic materials. Accordingly, the range of material selection becomes wider and a combination of materials that can be deposited by plating, which is favorable in cost efficiency and mass productivity, can be employed.

Furthermore, an additional feature of the magnetic head, in which the magnetic pole has a cross-sectional surface along the surface of the recording medium, the cross-sectional surface being narrow at a front part of the movement and being wide at a rear part of the movement, is preferable.

As a result of employing the magnetic pole with a cross-sectional surface along the surface of the recording medium, the cross-sectional surface being narrowed at a front part of the movement and being widened at a rear part of the movement, the failure of the front side of the magnetic pole running over to an adjacent track upon occurrence of a skew angle during the driving of the head can be prevented, thereby preventing side erasure which erases recorded information.

Furthermore, an additional feature of the magnetic head, in which the magnetic pole meets a relationship of S2/(S1+S2)>0.35 where the area of a surface of the first magnetic layer facing the surface of the recording medium is S1, and the area of a surface of the second magnetic layer facing the surface of the recording medium is S2, is preferable.

As a result of providing S2/(S1+S2)>0.35, the write core width can be narrowed while the O/W performance being maintained, making it possible to reliably preventing pole erasure.

Furthermore, an additional feature of the magnetic head, in which the magnetic pole has a saturation magnetic flux density greater than 2.1 T and a coercivity lower than 800 A/m for the entire layers included in the magnetic pole, is preferable.

As a result of employing the magnetic pole having a saturation magnetic flux density greater than 2.1 T and a coercivity lower than 800 A/m, both pole erasure prevention and a high recording density can reliably be achieved.

Furthermore, an additional feature of the magnetic head, in which the magnetic pole has an alloy film having a composition different from the compositions of the first magnetic layer and the second magnetic layer between the underlayer, and the first magnetic layer and the second magnetic layer, is preferable.

Furthermore, an additional feature in which the magnetic pole has a non-magnetic underlayer, and the first magnetic layer and the second magnetic layer are formed on the underlayer by plating, is preferable, and an additional feature in which the underlayer of the magnetic pole contains at least one kind of element from among Ru, Pd, Pt, Rh, Au, Cu, NiP, NiMo and NiCr, is further preferable.

In perpendicular head processing, when an unwanted plated underlayer portion is removed by means of ion milling after a magnetic pole is formed by plating, the removed underlayer portion may reattach to the magnetic pole side wall. When the plating underlayer is formed of a magnetic material, the re-adhesion layer has magnetism and thus it also functions as a portion of the magnetic pole, causing a problem in that the magnetic pole width increases and the cross-sectional surface shape deforms. As a result of forming the plating underlayer from a non-magnetic conductive material, the re-adhesion layer becomes non-magnetic, thereby the magnetic pole width increase and magnetic pole cross-sectional surface shape deformation due to the re-adhesion layer can be prevented. Also, when the underlayer is non-magnetic, the underlayer does not function as a part of the magnetic pole, and accordingly, the trouble of removing only an unwanted portion of the underlayer with high accuracy to conform to the magnetic pole width and shape, which become thinner toward to its tip, can be saved.

Furthermore, an additional feature of the magnetic head, in which the underlayer of the magnetic pole consists of Ru, is preferable.

The crystal structure of a magnetic film with a high percentage of Fe and a high saturation magnetic flux density is a body-centered cubic lattice, and the coercivity of a magnetic film with a body-centered cubic lattice can be lowered by controlling the magnetic film to have a (110) orientation. As a result of using Ru as an underlayer, a magnetic film with a body-centered cubic lattice can be controlled to have a (110) orientation, making it possible to lower the coercivity. Also, a magnetic film having a crystal structure of a face-centered cubic lattice tends to have a lowered coercivity irrespective of the underlayer, and even when using Ru as the underlayer, a low coercivity can also be obtained.

When using Ru as the underlayer, a volatile oxide easily is formed on the surface and a failure easily occurs during plating, and accordingly, it is preferable to form a thin conductive film such as NiFe on the Ru.

Furthermore, an additional feature of the magnetic head, in which the magnetic pole has a magnetic underlayer, and the first magnetic layer and the second magnetic layer are formed on the underlayer by plating is preferable, and an additional feature in which the underlayer of the magnetic pole contains at least one kind of element from among Ni, Fe and Co is further preferable.

A basic feature of an information storage device according to another aspect of the present invention, which accesses a recording medium for information storage and retrieval using a magnetic field, includes: a magnetic pole that faces a surface of the recording medium and produces a line of magnetic force intersecting the surface of the recording medium; a coil that excites the magnetic pole; and a movement mechanism that moves the magnetic pole relative to the surface of the recording medium in a direction along the surface, wherein the magnetic pole includes a laminate with a coercivity of 800 A/m or less, the laminate including two or more layers stacked in a direction along the movement relative to the surface of the recording medium, the two or more layers including a first magnetic layer located at a frontmost position of the movement, and a second magnetic layer located at a rearmost position of the movement, the second magnetic layer having a saturation magnetic flux density higher than a saturation magnetic flux density of the first magnetic layer.

According to the information storage device basic feature, it is possible to prevent pole erasure and record information with a high recording density.

Also, an additional feature of the aforementioned information storage device, in which the first magnetic layer has a composition of Ni₁₀₀₋ₓFeₓ (15≦x wt %), and the second magnetic layer has a composition of FeₓCo₁₀₀₋ₓ (65≦x≦75 wt %), is preferable.

According to this additional feature of the preferable information storage device, since the first magnetic layer has in-plane anisotropy, it is possible to lower the coercivity, preventing pole erasure. Also, as a result of the second magnetic layer having a composition of FeₓCo₁₀₀₋ₓ (65≦x≦75 wt %), a high saturation magnetic flux density can be achieved and the O/W performance can be enhanced.

Furthermore, an additional feature of the aforementioned information storage device, in which the first magnetic layer has a composition of CoₓNi_{y}Fe_{z} (x+y+z=100, 0<y≦10, 0<x≦33 wt %), and the second magnetic layer has a composition of FeₓCo₁₀₀₋ₓ (65≦x≦75 wt %), is preferable.

According to this additional feature of the preferable information storage device, the coercivity of the magnetic pole can be restrained to 800 A/m or less, ensuring reliable pole erasure prevention.

Furthermore, an additional feature of the aforementioned information storage device, in which the first magnetic layer has a composition of FeₓCo₁₀₀₋ₓ (75≦x wt %), and the second magnetic layer has a composition of FeₓCo₁₀₀₋ₓ (65≦x≦75 wt %), is preferable.

According to this additional feature of preferable information storage device, it is possible to restrain magnetostriction in the first magnetic layer, lowering the coercivity.

For the information storage device, only basic features have been mentioned here, and the information storage device includes not only the above features, but also various features corresponding to the respective features of the magnetic head mentioned above.

As described above, according to the basic features of the magnetic head and the information storage device of the present invention, it is possible to achieve both pole erasure and side erasure prevention, and a high recording density, while curbing a rise in manufacture costs.

### BRIEF DESCRIPTION OF THE DRAWINGS

FIG. 1 is a diagram for explaining the operation principle of perpendicular recording;

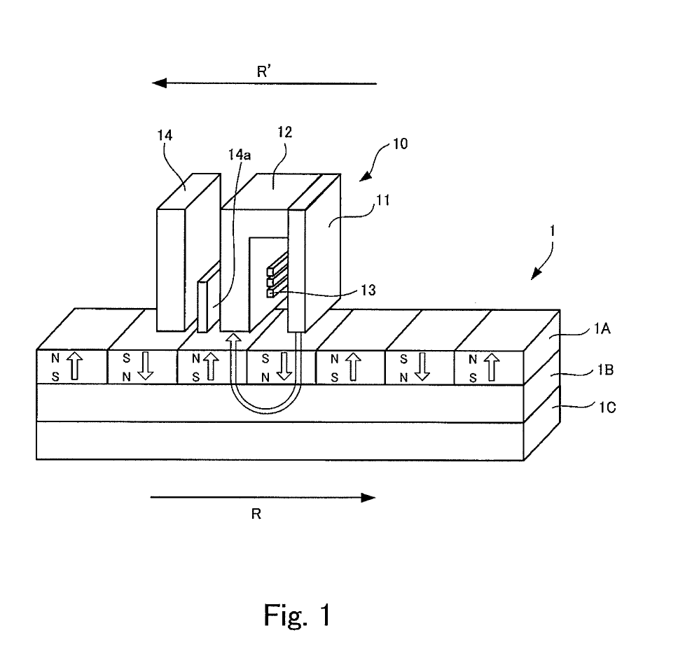

FIG. 2 is an appearance diagram of a hard disk device;

FIG. 3 is a functional block diagram of the hard disk device;

FIG. 4 is a schematic configuration diagram of a magnetic head;

FIG. 5 is a schematic diagram of a tip portion of a main magnetic pole;

FIG. 6 is a diagram of the main magnetic pole viewed from the magnetic disk side;

FIGS. 7(A) and 7(B) are diagrams each illustrating the main magnetic pole having a first layer and a second layer formed on an underlayer;

FIG. 8 is a graph indicating the relationship between main magnetic pole coercivity Hc [A/m] and occurrence or non-occurrence of pole erasure;

FIG. 9 is a graph indicating the saturation magnetic flux densities and coercivities of various magnetic materials that have conventionally and widely been used as materials for main magnetic poles, and a laminated film of plural magnetic materials;

FIG. 10 is a diagram indicating the relationship between the percentage of Fe and saturation magnetic flux density Bs in an FeCo alloy, which is used as a second magnetic layer;

FIG. 11 is a diagram indicating the percentage of Fe and saturation magnetic flux density Bs in an NiFe alloy, which is used as a first magnetic layer;

FIG. 12 is a diagram indicating the relationship between the percentage of Fe and coercivity Hc in an NiFe alloy;

FIG. 13 is a diagram indicating the relationship between the percentage of Ni and coercivity Hc in an NiFe alloy;

FIG. 14 is a diagram indicating the B-H curve of an NiFe alloy having no vertical anisotropy;

FIG. 15 is a diagram indicating the B-H curve of an NiFe alloy having vertical anisotropy;

FIG. 16 is a diagram indicating the relationship between the thickness of a first magnetic layer relative to that of the entire main magnetic pole, and coercivity Hc;

FIG. 17 is a diagram indicating the relationship between the thickness of a first magnetic layer relative to that of the entire main magnetic pole, and saturation magnetic flux density Bs;

FIG. 18 is a diagram indicating the relationship between the respective percentages of Co, Ni and Fe in a CoNiFe alloy, and saturation magnetic flux density Bs;

FIG. 19 is a diagram indicating the relationship between the respective percentages of Co, Ni and Fe in a CoNiFe alloy, and coercivity Hc;

FIG. 20 is a diagram indicating the relationship between the percentage of Fe and magnetostriction λ in an FeCo alloy;

FIG. 21 is a diagram indicating the relationship between magnetostriction λ and coercivity Hc in an FeCo alloy;

FIG. 22 is a diagram indicating the relationship between the percentage of Fe and the coercivity Hc in an FeCo alloy by underlayer; and

FIG. 23 is a diagram indicating the relationship between O/W performance and write core width.

### DETAILED DESCRIPTION OF THE INVENTION

Hereinafter, a specific embodiment of the basic features and additional features described above, with reference to the drawings.

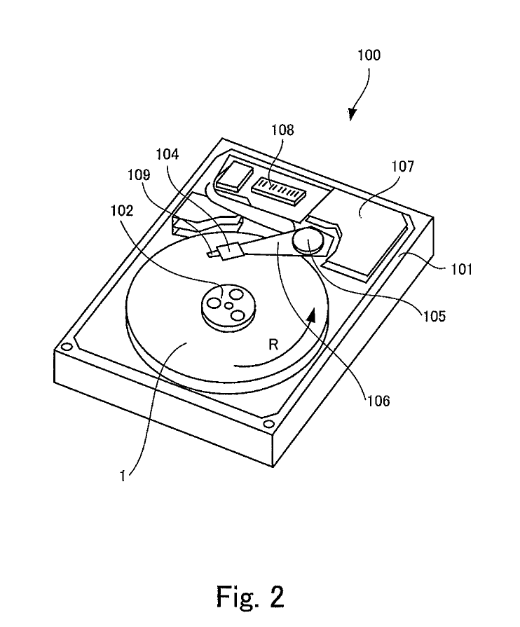

FIG. 2 is an appearance diagram of a hard disk device 100, which is a specific embodiment of the aforementioned information storage device.

The hard disk device 100 shown in FIG. 2 is used by being connected to or incorporated in a host apparatus typified by, for example, a personal computer.

As shown in FIG. 2, a housing 101 in the hard disk device 100 includes a magnetic disk 1 in which information is recorded, a spindle motor 102 that rotates the magnetic disk 1 in an arrow R direction, a floating head slider 104 provided near a surface of the magnetic disk 1 and facing the surface of the magnetic disk 1, an arm axis 105, a carriage arm 106 having the floating head slider 104 fixed to an tip thereof, the carriage arm 106 moving above the magnetic disk 1 along the surface thereof about the arm axis 105, a voice coil motor 107 that drives the carriage arm 106, and a control circuit 108 that controls the operation of the hard disk device 100. The combination of the spindle motor 102 and the voice coil motor 107 corresponds to an example of the movement mechanism in the basic feature of the information storage device described in “Summary of the Invention.”

A tip of the floating head slider 104 is provided with a magnetic head 109, which is a specific feature of the aforementioned magnetic head and applies a magnetic field to the magnetic disk 1, and the hard disk device 100 records information on the magnetic disk 1 or reads information recorded on the magnetic disk 1, using this magnetic field. In a normal situation, the hard disk device 100 includes plural magnetic disks 1, and is provided with the magnetic head 109 for each of the plural magnetic disks. However, for ease of description, the description of the present embodiment is given focusing on one magnetic disk 1 and one magnetic head 109 provided for the magnetic disk 1.

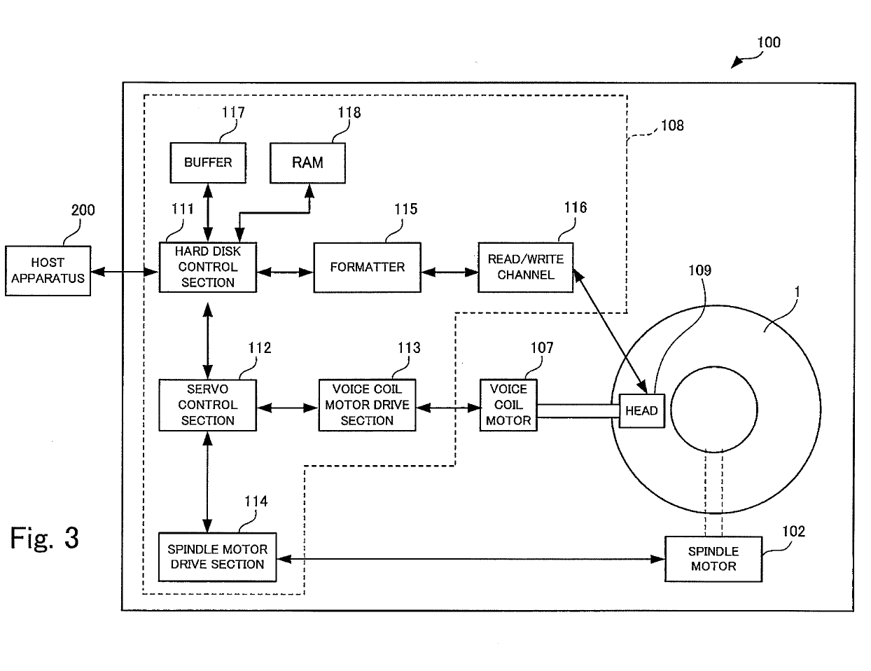

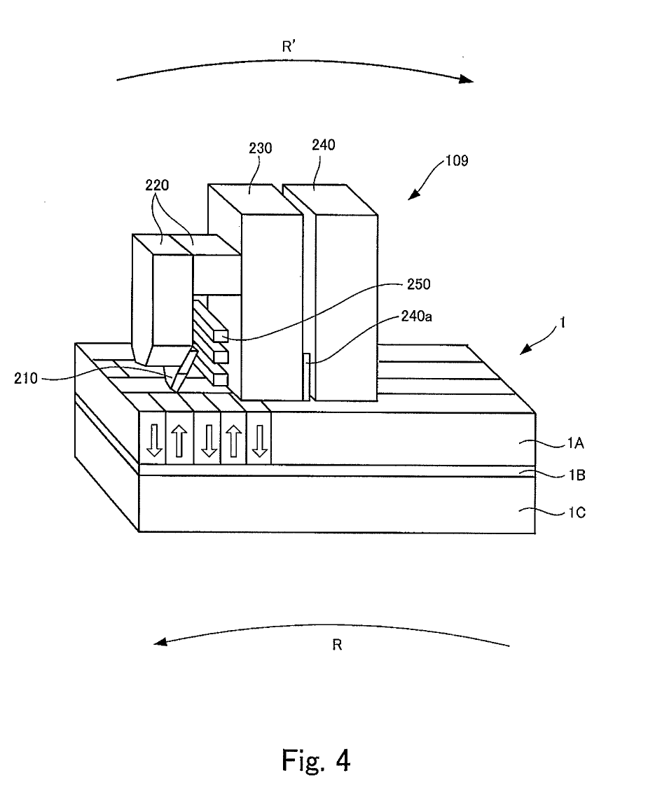

FIG. 3 is a functional block diagram of the hard disk device 100, and FIG. 4 is a schematic configuration diagram of the magnetic head 109.

As shown in FIG. 3, the hard disk device 100 includes the spindle motor 102, the voice coil motor 107, the control circuit 108 and the magnetic head 109, etc, which are shown also in FIG. 2. The control circuit 108 includes a hard disk control section 111 that controls the entire hard disk device 100, a servo control section 112 that controls the spindle motor 102 and the voice coil motor 107, a voice coil motor drive section 113 that drives the voice coil motor 107, a spindle motor drive section 114 that drives the spindle motor 102, a formatter 115 that formats the magnetic disk 1, a read/write channel 116 that generates write current that carries write information to be written in the magnetic disk 1, and converts reproduction signals obtained by reading via the magnetic head 109 information recorded in the magnetic disk 1, into digital data, a buffer 117 which is used as a cache in the hard disk control section 111, and a RAM 118 which is used as a work area in the hard disk control section 111.

FIG. 4 shows a partial cross-sectional structure of the magnetic head 109. This magnetic head 109 appears to move in an arrow R′ direction, which is opposite to the direction of the magnetic disk 1 rotation as a result of the magnetic disk 1 being rotated in the arrow R direction in a state in which the magnetic head 109 is positioned on the magnetic disk 1.

The magnetic head 109 is provided with a main magnetic pole 210 that produces a magnetic flux, coils 250 that generate a magnetic field, an auxiliary magnetic pole 230 that picks up the magnetic flux produced by the main magnetic pole 210 and feeds it back to the coils 250 and the main magnetic pole 210, and a reproducing head 240 that reads information recorded in the magnetic disk 1 in this order from the rear side of the movement direction R′, and it also includes a yoke 220 connecting the main magnetic pole 210 and the auxiliary magnetic pole 230. The main magnetic pole 210 corresponds to an example of the magnetic pole in the aforementioned the information storage device and the basic features of the magnetic head, and a coil 250 corresponds to an example of the coil in the aforementioned information storage device and basic features of the magnetic head.

Also, the magnetic disk 1 has a recording layer 1A in which information is recorded, and a soft magnetic layer 1B formed of a soft magnetic material deposited on a substrate 1C. The magnetic disk 1 corresponds to an example of the recording medium in the aforementioned information storage device and basic features of the magnetic head.

Hereinafter, a method for accessing the magnetic disk 1 will be described using FIGS. 3 and 4.

When writing information on the magnetic disk 1, write information to be recorded in the magnetic disk 1 and a logical address for the write position is sent from the host apparatus 200, which is shown in FIG. 3, to the hard disk device 100. The hard disk control section 111 converts the logical address to a physical address and conveys the physical address to the servo control section 112.

The servo control section 112 conveys an instruction to rotate the spindle motor 102, to the spindle motor drive section 114, and conveys an instruction to move the carriage arm 106 (see FIG. 2), to the voice coil motor drive section 113. The spindle motor drive section 114 drives the spindle motor 102 to rotate the magnetic disk 1, and the voice coil motor drive section 113 drives the voice coil motor 107 to move the carriage arm 106. As a result, the magnetic head 109 is positioned on the magnetic disk 1.

When the magnetic head 109 is positioned, the hard disk control section 111 conveys write signals to the read/write channel 116, and the read/write channel 116 applies write current carrying write information to the magnetic head 109.

In the magnetic head 109, the write signals are input to the coils 250, which are shown in FIG. 4, and the coils 250 generate a magnetic field having a direction according to the write signals. In the main magnetic pole 210, a magnetic flux according to the magnetic field that has been generated by the coils 250, is released toward the magnetic disk 1, and as a result, magnetization having a direction according to the information is formed on the recording layer 1A of the magnetic disk 1, thereby the information being recorded on the magnetic disk 1. The magnetic flux that has formed the magnetization on the recording layer 1A is collected by the auxiliary magnetic pole 230 via the soft magnetic layer 1B, and fed back to the main magnetic pole 210 via the yoke 220.

Also, when reading information recorded in the magnetic disk 1, a logical address for the recording position where the information is recorded is sent from the host apparatus 200 shown in FIG. 3 to the hard disk device 100. Subsequently, as in information writing, in the hard disk control section 111, the logical address is converted to a physical address, the spindle motor 102 is rotationally driven to rotate the magnetic disk 1, and the voice coil motor 107 is driven to move the carriage arm 106, thereby the magnetic head 109 being positioned on the magnetic disk 1.

A reproducing element 240a that provides a resistance value according to the magnetic field generated from magnetization is incorporated in the magnetic head 109 shown in FIG. 4, and as a result of making current flow in the reproducing element 240a, reproduction signals are generated according to the magnetization status. In the present embodiment, the specific type of the reproducing element 240a is not specifically limited, but for this reproducing element 240a, for example, a GMR (giant magnetoresistance) element or a TMR (tunnel magnetoresistance) element can be employed.

The reproduction signals, after being converted to digital data in the read/write channel 116 shown in FIG. 3, are sent to the host apparatus 200 via the hard disk control section 111.

Basically, the magnetic disk 1 is accessed for information storage and retrieval in such a manner as described above.

Next, a further detailed description will be given of the magnetic head 109.

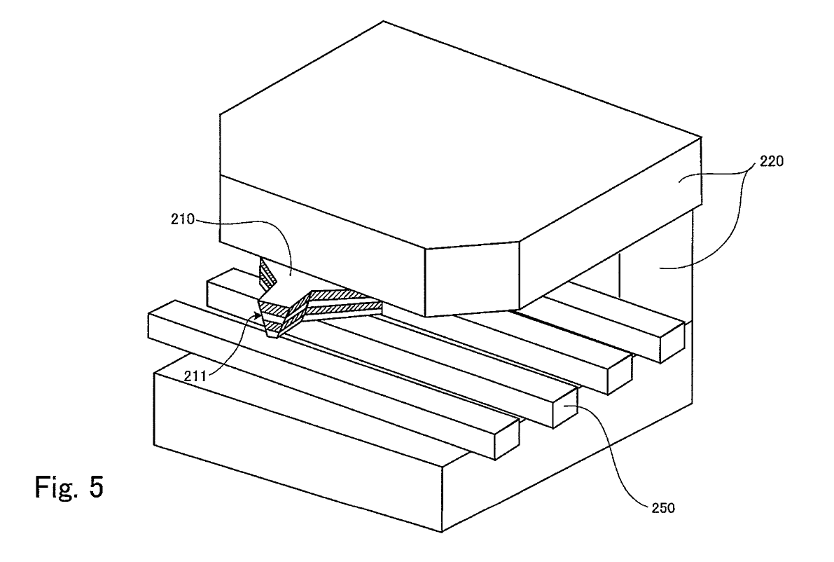

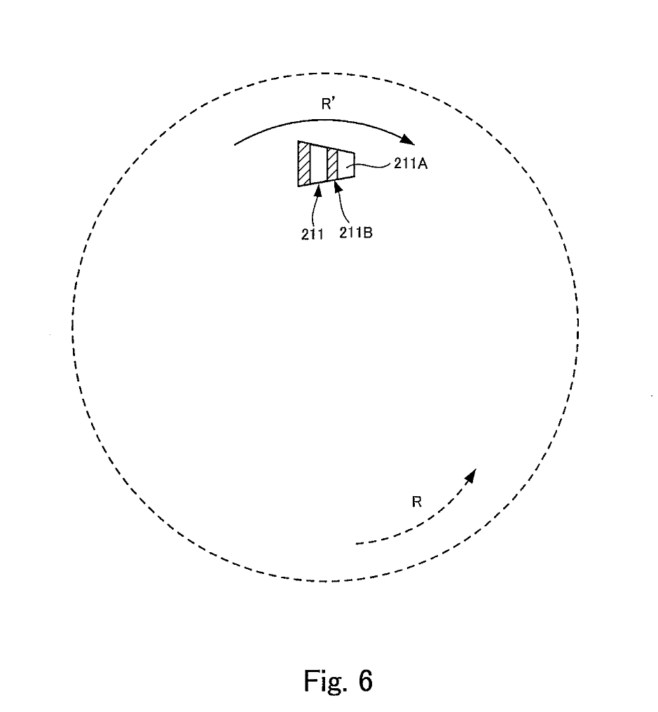

FIG. 5 is a schematic diagram of a tip portion of the main magnetic pole 210, and FIG. 6 is a diagram of the main magnetic pole 210 viewed from the magnetic disk 1 side.

As shown in FIG. 5, the main magnetic pole 210 is formed so that the width of its surface facing the magnetic disk 1 becomes narrower toward the front of the magnetic disk 1 movement direction R′ and becomes wider toward the rear of the movement direction R′. As a result of the main magnetic pole 210 having a shape tapered from the rear to the front side of the movement direction R′, a failure that the front side of the main magnetic pole 210 runs over to an adjacent track when a skew angle occurs during the driving of the head can be prevented, making it possible to prevent side erasure, which erase recorded information.

Also, as shown in FIG. 6, the main magnetic pole 210 has first layers 211A with a relatively small saturation magnetic flux density (e.g., FeNi: saturation magnetic flux density Bs is 2.1 [T]), and second layers 211B with a relatively large saturation magnetic flux density (e.g., FeCo: saturation magnetic flux density Bs is not less than 2.3 [T]) alternately deposited in four layers in total along the magnetic disk 1 movement direction R′, and as a result, the saturation magnetic flux density Bs of the entire main magnetic pole 210 is not less than 2.1 [T], and the coercivity Hc is restrained to 800 [A/m] or less. The first layer 211A corresponds to an example of the first magnetic layer in the aforementioned information storage device and basic features of the magnetic head, and the second layer 211B corresponds to an example of the second magnetic layer in the aforementioned information storage device and basic features of the magnetic head. In the present embodiment, since the coercivity Hc of the main magnetic pole 210 is 800 [A/m] or less, it is possible to reliably prevent pole erasure. Also since the first layers 211A and the second layers 211B are alternately deposited so that the first layer 211A with a small saturation magnetic flux density Bs is disposed at the front of the movement direction R′ where side erasure easily occurs, and the second magnetic layer 211B with a large saturation magnetic flux density Bs is disposed at the rear side of the movement direction R′ where side erasure is difficult to occur, it is possible to efficiently prevent side erasure and enhance the O/W performance.

Also, for the materials for forming the first layers 211A and the second layers 211B, a combination of magnetic materials with saturation magnetic flux densities different from each other can be used, and a combination of materials that can be deposited by plating, which is favorable in cost efficiency and mass productivity, can also be used. In the present embodiment, a thin conductive film (e.g., NiFe) is formed on an underlayer of Ru, which is a non-magnetic material, and the first layers 211A and the second layers 211B are further formed thereon by plating.

As a result of using Ru as the underlayer, a magnetic layer with a body-centered cubic lattice in which the percentage of Fe is high and the saturation magnetic flux density is also high can be controlled to have a (110) orientation, making it possible to reduce the coercivity Hc. Also, as a result of forming a thin conductive film on Ru, a failure in plating can be reduced.

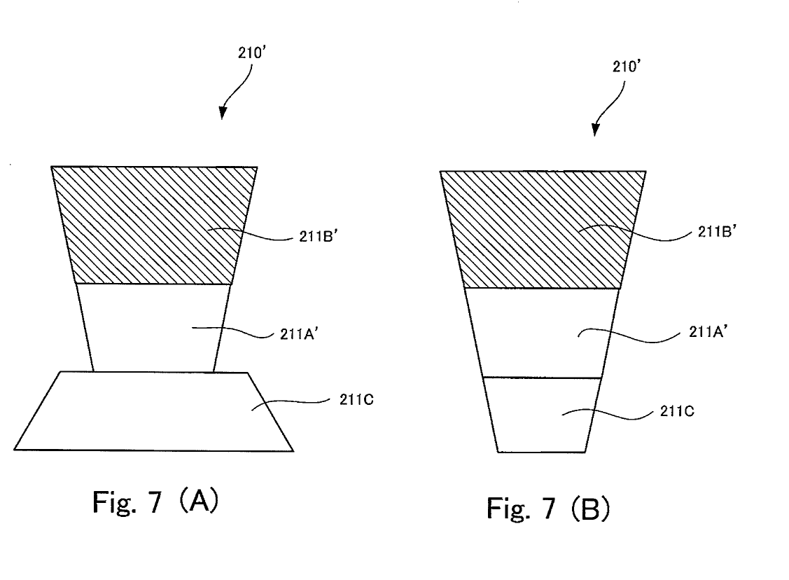

FIGS. 7(A) and 7(B) are diagrams each illustrating a main magnetic pole with a first layer and a second layer formed on an underlayer.

As a shown in FIG. 7(A), when an unwanted plating underlayer portion is removed by means of ion milling after a main magnetic pole 210′ is formed by plating, the removed portion of the underlayer 211C may reattach to the main magnetic pole 210′. When the underlayer 211C is formed of a magnetic material, this underlayer 211C portion also functions as a portion of the main magnetic pole 210′, and accordingly, as shown in FIG. 7(B), it is necessary to cut the underlayer 211C so as to become thinner toward its tip. In the present embodiment, since the underlayer 211C is formed of a non-magnetic material, the trouble of cutting the underlayer 211C with high accuracy to conform to the width of the main magnetic pole can be saved. Also, increased width of a magnetic pole and deformation of a magnetic pole cross-sectional surface due to the reattaching layer can be prevented. Also, it is preferable to use a material containing at least one kind of element from among Ru, Pd, Pt, Rh, Au, Cu, NiP, NiMo and NiCr for the non-magnetic underlayer 211C. Also, for a magnetic underlayer, a material containing at least one kind of element from among Ni, Fe and Co can be employed. In particular, when NiFe is used for the underlayer, as in the Ru underlayer, a magnetic layer with a body-centered cubic lattice where the percentage of Fe is high and the saturation magnetic flux density is also high can be controlled to have a (110) orientation, making it possible to reduce the coercivity Hc.

As described above, according to the present embodiment, it is possible to achieve both pole erasure and side erasure prevention and a high recording density, while curbing a rise in manufacture costs.

Although the above description has been given for an example of a main magnetic pole with first layers and second layers alternately deposited in four layers in total, the magnetic pole in the magnetic head and information storage device described in the “SUMMARY OF THE INVENTION” may have a first magnetic layer and a second magnetic layer deposited in two layers. It may also have first magnetic layers and second magnetic layers deposited in four layers or more, or may also have a third layer, which is different from the first magnetic layers and the second magnetic layers. This third layer may be a non-magnetic material if it is formed of a material having conductivity. If this third layer is a magnetic material, it is preferable that its coercivity is as low as possible from the viewpoint of pole erasure and side erasure prevention.

Also, when a first magnetic layer and a second magnetic layers are deposited, the saturation magnetic flux density Bs of the entire magnetic head is a sum of the saturation magnetic flux densities of the individual layers, but the coercivity Hc of the entire magnetic head cannot be determined simply from the coercivities of the individual layers because the coercivities vary depending on their crystallinity, etc. Accordingly, it is preferable that the saturation magnetic flux density of the entire magnetic head is enhanced by making the layer thickness of the second magnetic layer with a high saturation magnetic flux density to be as thick as possible (S2/(S1+S2)>0.35 where the area of the surface of the first magnetic layer facing a surface of the recording medium is S1, and the area of the surface of the second magnetic layer facing a surface of the recording medium is S2).

Also, for the second magnetic layer in the magnetic head and information storage device basic features, FeCo (60<Fe<80 wt %) or FeCoNi (55<Fe<80 at %, 20<Co<45 wt % and 0<Ni<20 wt %), etc., can be employed, and for the first magnetic layer in the magnetic head and information storage device basic features, it is preferable to use an FeNi alloy (Fe>75 wt %) or an FeCo alloy (Fe>75 wt %), a CoNiFe alloy (60≦Co≦80, 10≦Fe≦20 wt %), FeCoNi (55<Fe<80 at %, 20<Co<45 wt % and 0<Ni<20 wt %) etc. Furthermore, if a third layer is deposited between the first magnetic layer and the second magnetic layer, for the third layer, a permalloy, 50%-nickel permalloy, NiP, NiFeMo, NiMo, Ru, Pd, Pt, Rh or Cu, etc., can be used.

### EXAMPLES

Hereinafter, examples of the present invention will be described.

First, a first example will be described.

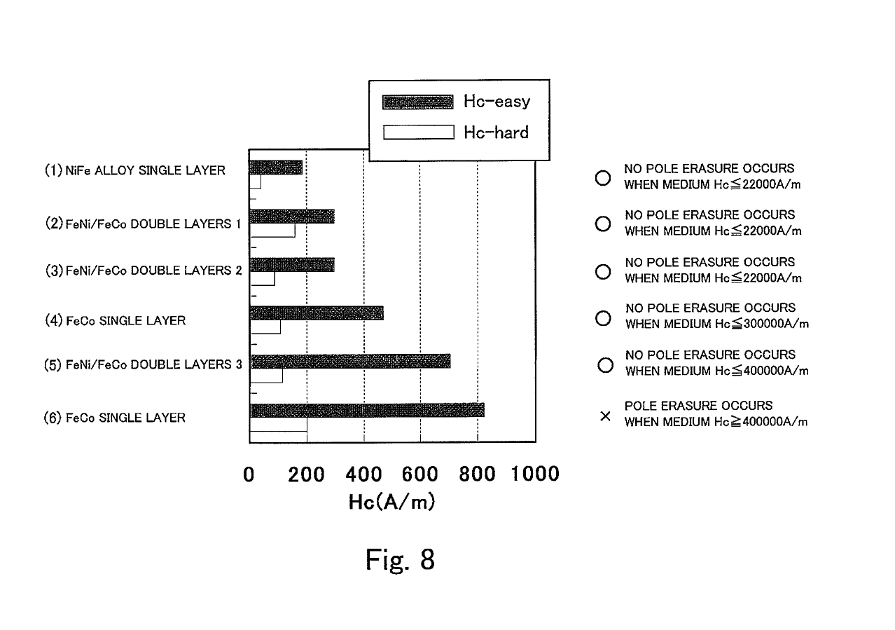

FIG. 8 is a graph indicating the relationship between main magnetic pole coercivity Hc [A/m] and occurrence or non-occurrence of pole erasure.

In FIG. 8, for each of (1) a first main magnetic pole formed of an NiFe alloy alone, (2) a second main magnetic pole formed of an FeNi alloy and an FeCo alloy, (3) a third main magnetic pole formed of an FeNi alloy and an FeCo alloy, (4) a fourth main magnetic pole formed of an FeCo alloy alone, (5) a fifth main magnetic pole formed of an FeNi alloy and an FeCo alloy, and (6) a sixth main magnetic pole formed of an FeCo alloy alone, the coercivity Hc [A/m] in the hard axis direction is shown with a white bar, and the coercivity Hc [A/m] in the easy axis direction is shown with a black bar, and the result of confirmation of pole erasure occurrence is also shown.

As shown in FIG. 8, pole erasure occurs only in the sixth main magnetic pole having an easy axis direction coercivity Hc in the axis direction greater than 800 [A/m]. Accordingly, it can be understood that pole erasure can be prevented by adjusting the coercivity Hc of the entire main magnetic pole to be 800 [A/m] or less.

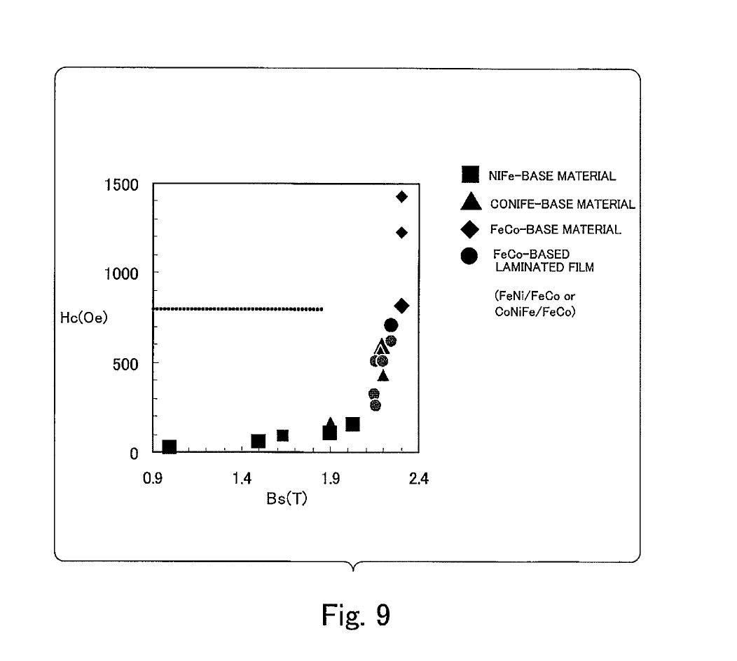

FIG. 9 is a graph indicating the saturation magnetic flux densities and coercivities of various magnetic materials that have conventionally and widely been used as materials for main magnetic poles, and a lamianated film of plural magnetic materials.

In FIG. 9, the abscissa axis corresponds to saturation magnetic flux density Bs [T], and the ordinate axis corresponds to coercivity Hc [A/m], and CoNiFe-based magnetic materials are plotted with triangles, NiFe-based materials are plotted with squares, FeCo-based materials are plotted with diamonds, laminated films of FeNi and FeCo, and laminated films of CoNiFe and FeCo are plotted with circles.

As described above, in order to prevent pole erasure, it is necessary that the coercivity Hc of the main magnetic pole be no more than 800 [A/m], and furthermore, in order to achieve a high recording density, it is required that the saturation magnetic flux density Bs of the main magnetic pole is not less than 2.1 [T]. As shown in FIG. 9, each of the NiFe-based materials (materials plotted with squares) has a coercivity Hc of 800 [A/m] or less, but has a small saturation magnetic flux density Bs. Each of the CoNiFe-based materials (materials plotted with triangles) has an overly high coercivity Hc or an overly small saturation magnetic flux density Bs, so none of them meets both conditions. Only one of the FeCo-based materials (materials plotted with diamonds) meets both conditions, but the others have a problem in that their coercivities Hc are overly high. As described above, there are only a few materials that can reliably achieve both a high recording density and pole erasure prevention with one layer alone. Meanwhile, laminated films of FeNi and FeCo and laminated films of CoNiFe and FeCo (materials plotted with circles) meet both coercivity Hc and saturation magnetic flux density Bs conditions. Accordingly, it can be understood that the coercivity Hc of the entire main magnetic pole can be restrained while a high saturation magnetic flux density Bs being maintained, by forming the main magnetic pole of plural layers.

Next, a second example will be described.

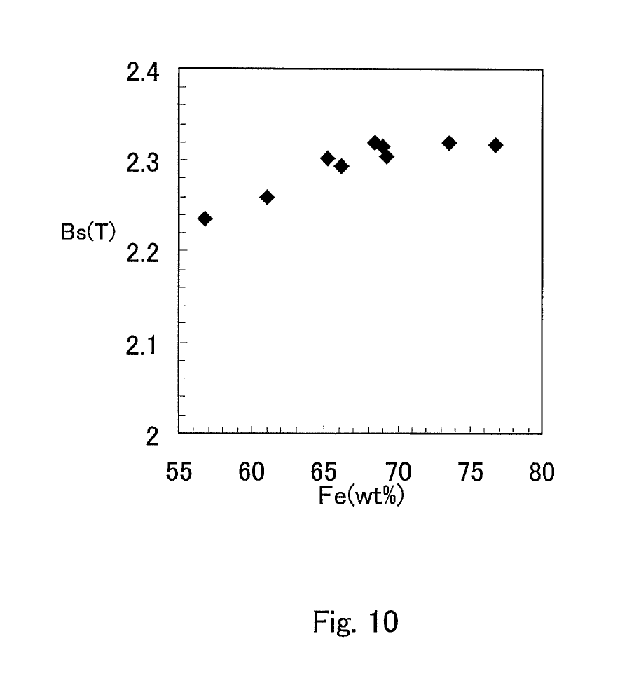

FIG. 10 is a diagram indicating the relationship between the percentage of Fe and saturation magnetic flux density Bs in an FeCo alloy, which is used as the second magnetic layer.

As shown in FIG. 10, when the percentage of Fe in an FeCo alloy increases, the saturation magnetic flux density Bs also become higher, and furthermore, when the percentage of Fe exceeds 75%, the saturation magnetic flux density Bs is gradually lowered. In order to provide a saturation magnetic flux density Bs of not less than 2.1 [T] in the entire main magnetic pole and to enhance O/W, it is sufficient if the FeCo alloy, which is the second magnetic layer, has a saturation magnetic flux density Bs exceeding 2.1 [T], but in order to provide a sharp magnetic field gradient and also improve the recording performance, it is desirable that the saturation magnetic flux density Bs is as high as possible, and a saturation magnetic flux density Bs of around 2.3 [T] is required. This condition is met if the percentage of Fe is from 65% to 75%, and the effectiveness of the present invention can thereby be proven.

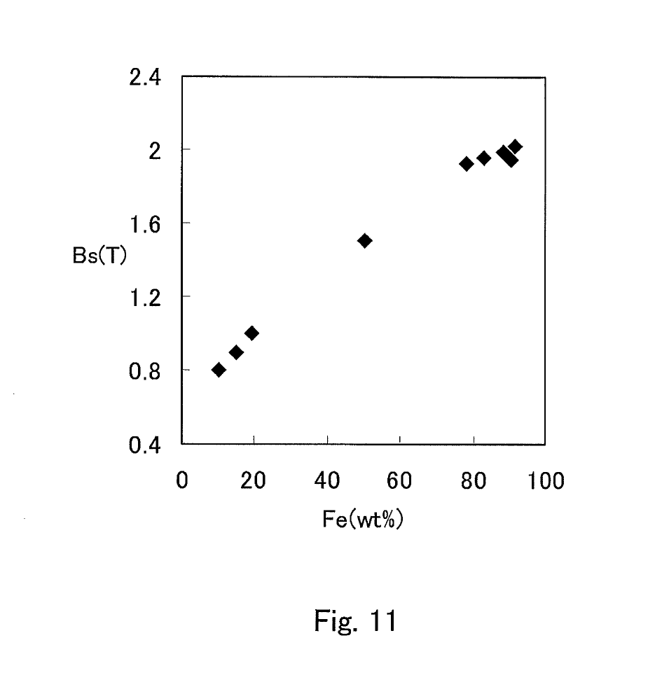

FIG. 11 is a diagram indicating the percentage of Fe and saturation magnetic flux density Bs in an NiFe alloy, which is used as the first magnetic layer.

As shown in FIG. 11, when the percentage of Fe in an NiFe alloy increases, the saturation magnetic flux density Bs is also enhanced. However, since the first magnetic layer has only a small impact on the O/W performance, a low coercivity Hc is required rather than a high saturation magnetic flux density Bs.

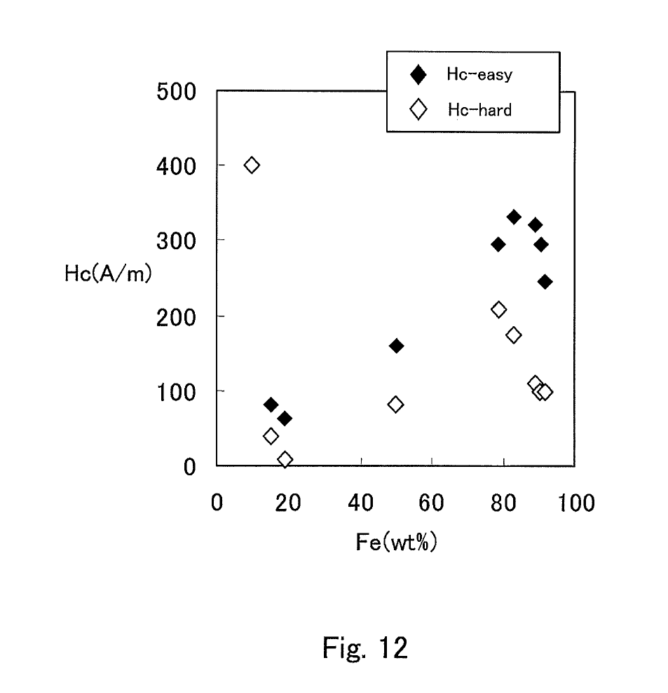

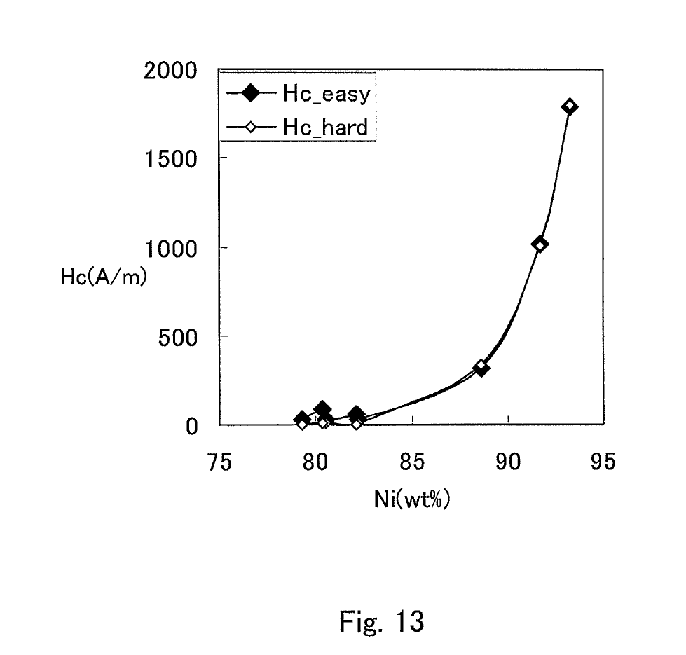

FIG. 12 is a diagram indicating the relationship between the percentage of Fe and coercivity Hc in an NiFe alloy, and FIG. 13 is a diagram indicating the relationship between the percentage of Ni and coercivity Hc in an NiFe alloy. The percentage of Ni is referred to as the percentage of Ni around the Ni-content region corresponding to the low-Fe-content region in FIG. 12 where Hc sharply deteriorates. The coercivities in the easy axis direction are plotted in black and the coercivities in the hard axis direction are plotted in white.

As shown in FIGS. 12 and 13, in an NiFe alloy, from around the point where the percentage of Fe is less than 15% and the percentage of Ni exceeds 85%, the coercivity Hc sharply increase. This can be considered to be resulted from vertical anisotropy occurring in an NiFe alloy with the percentage of Fe percentage being less than 15% (that is, the percentage of Ni is more than 85%).

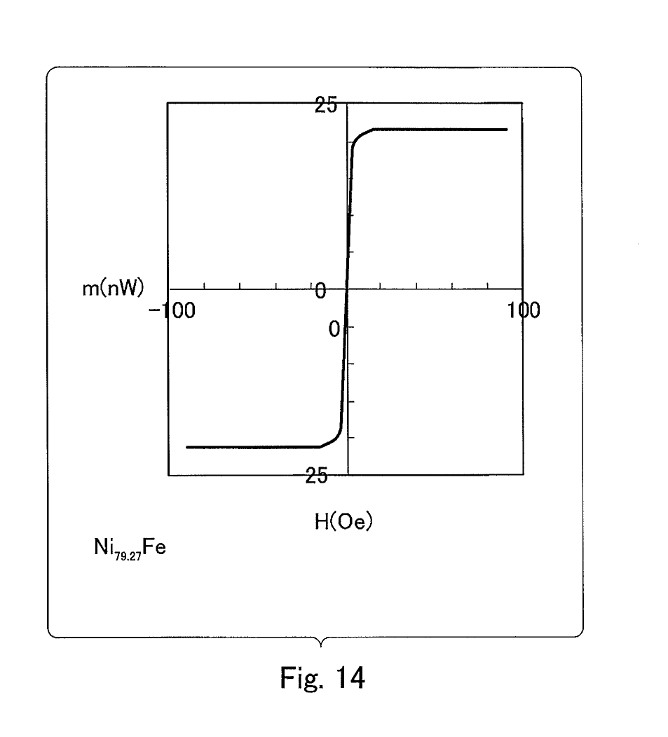

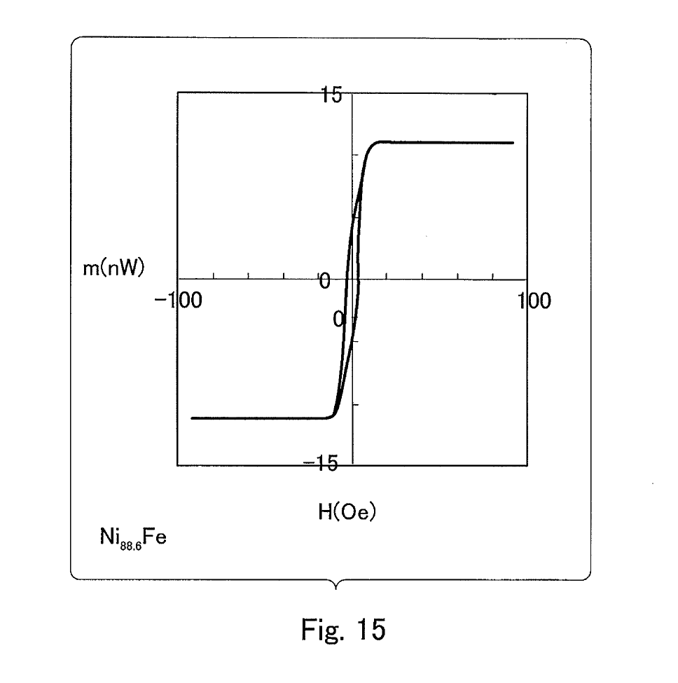

FIG. 14 is a diagram indicating the B-H curve of an NiFe alloy having no vertical anisotropy, and FIG. 15 is a diagram indicating the B-H curve of an NiFe alloy having vertical anisotropy.

FIG. 14 shows the B-H curve of an NiFe alloy in which the percentage of Ni is 79.27%, and FIG. 15 shows the B-H curve of an NiFe alloy in which the percentage of Ni is 88.6%. As shown in FIG. 14, in the NiFe alloy in which the percentage of Ni is 79.27%, no vertical anisotropy occurs and the coercivity Hc is restrained. However, as shown in FIG. 15, in the NiFe alloy in which the percentage of Ni is 88.6%, vertical anisotropy occurs and the coercivity Hc deteriorates. Accordingly, it is preferable that the percentage of Fe in an NiFe alloy is not less than 15%.

Next, a third example will be described.

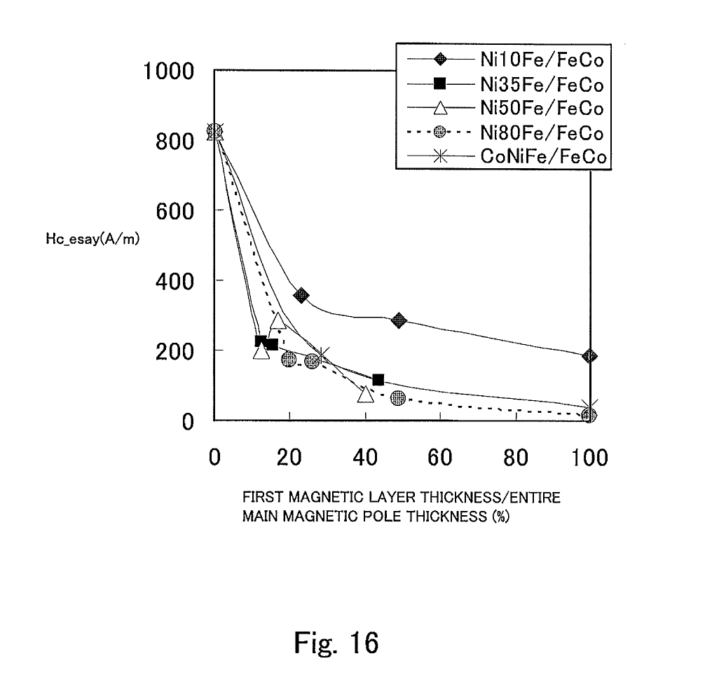

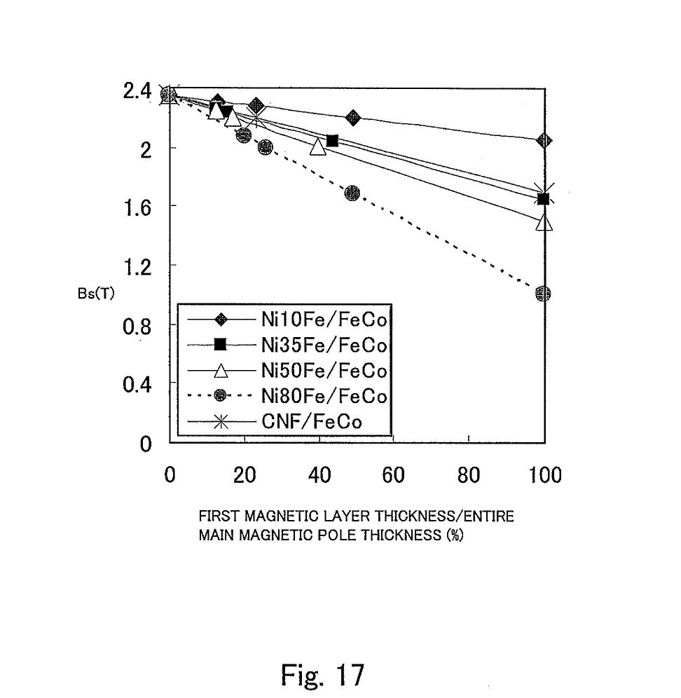

FIG. 16 is a diagram indicating the relationship between the thickness of a first magnetic layer relative to that of the entire main magnetic pole, and coercivity Hc, and FIG. 17 is a diagram indicating the relationship between the thickness of a first magnetic layer relative to that of the entire main magnetic pole, and saturation magnetic flux density Bs.

In FIGS. 16 and 17, (1) the results of a first main magnetic pole with a first magnetic layer of an NiFe alloy (with an Ni content of 10%) and a second magnetic layer of an FeCo alloy deposited are plotted with diamonds, (2) the results of a second main magnetic pole with a first magnetic layer of an NiFe alloy (with an Ni content of 35%), and a second magnetic layer of an FeCo alloy deposited are plotted with squares, (3) the results of a third main magnetic pole with a first magnetic layer of an NiFe alloy (with an Ni content of 50%) and a second magnetic layer of an FeCo alloy deposited are plotted with triangles, (4) the results of a fourth main magnetic pole with a first magnetic layer of an NiFe alloy (with an Ni content of 80%) and a second magnetic layer of an FeCo alloy deposited are plotted with circles, and (5) the results of a fifth main magnetic pole with a first magnetic layer of a CoNiFe alloy and a second magnetic layer of an FeCo alloy deposited are plotted with crosses.

As shown in FIG. 16, the first magnetic pole in which the percentage of Fe in the NiFe alloy is 90% has a smaller decrease of the coercivity Hc compared to the other magnetic poles. As shown in FIG. 17, the fourth magnetic pole in which the percentage of Fe in the NiFe alloy is 20% has a larger decrease of the saturation magnetic flux density Bs compared to the other magnetic poles. In view of these results, in the examples in FIGS. 16 and 17, the second magnetic pole in which the percentage of Fe is 65% and the third magnetic pole in which the percentage of Fe is 50% are preferable. At the portion where the thickness of the first magnetic layer relative to the main magnetic pole is thin, the fourth magnetic pole in which the percentage of Fe is 20% is also preferable in addition to the second magnetic pole in which the percentage of Fe is 65% and the third magnetic pole in which the percentage of Fe is 50%. According to the above, it can be understood that both conditions for the coercivity Hc and the saturation magnetic flux density Bs can be met if the percentage of Fe is from 18% to 70%. It can also be understood that both pole erasure prevention and O/W performance enhancement can be achieved by restraining the percentage of the thickness of an NiFe alloy relative to the entire main magnetic pole to around 17%, and enhancing the percentage of the FeCo alloy, which has a large impact on the saturation magnetic flux density of the entire magnetic pole.

Next, a fourth example will be described.

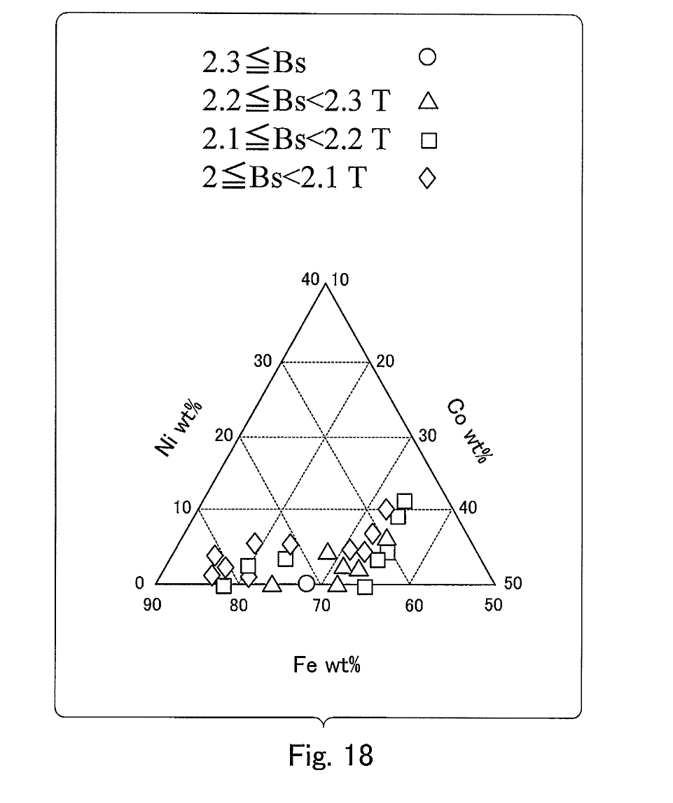

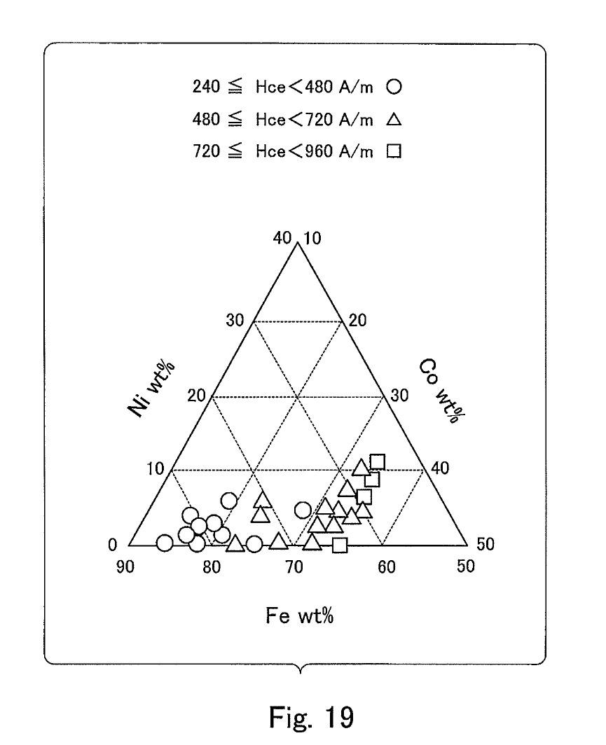

FIG. 18 is a diagram indicating the relationship between the respective percentages of Co, Ni and Fe in a CoNiFe alloy, and saturation magnetic flux densities Bs, and FIG. 19 is a diagram indicating the relationship between the respective percentages of Co, Ni and Fe in a CoNiFe alloy, and coercivities Hc.

In FIG. 18, CoNiFe alloy compositions with a saturation magnetic flux density Bs of not less than 2.3 [T] are plotted with circles, CoNiFe alloy compositions with a saturation magnetic flux density Bs of not less than 2.2 [T] and less than 2.3 [T] are plotted with triangles, CoNiFe alloy compositions with a saturation magnetic flux density Bs of not less than 2.1 [T] and less than 2.2 [T] are plotted with squares, and CoNiFe alloy compositions with a saturation magnetic flux density Bs of not less than 2 [T] and less than 2.1 [T] are plotted with diamonds. As shown in FIG. 18, it can be understood that each CoNiFe alloy with a saturation magnetic flux density Bs of more than 2.1 [T] has a low percentage of Ni.

Also, in FIG. 19, CoNiFe alloy compositions with a coercivity Hc of not less than 240 [A/m] and less than 480 [A/m] are plotted with circles, CoNiFe alloy compositions with a coercivity Hc of not less than 480 [A/m] and less than 720 [A/m] are plotted with triangles, and CoNiFe alloy compositions with a coercivity Hc of not less than 720 [A/m] and less than 960 [A/m] are plotted with squares. As shown in FIG. 19, it can be understood that in order to restrain the coercivity Hc to less than 720 [A/m], it is necessary to make the percentage of Co to be 33% or less and also to make the percentage of Ni to be 10% or less.

Next, a fifth example will be described.

In the fifth example, a first magnetic layer and a second magnetic layer are both made of FeCo alloys, but their percentages of Fe are different from each other. The first magnetic layer has a composition of FeₓCo₁₀₀₋ₓ (75≦x wt %), and the second magnetic layer has a composition of FeₓCo₁₀₀₋ₓ (65≦x≦75 wt %). As shown in FIG. 10, when the percentage of Fe exceeds 75%, the saturation magnetic flux density Bs is lowered, so plural magnetic layers with their saturation magnetic flux densities Bs different from each other can be deposited using FeCo alloys.

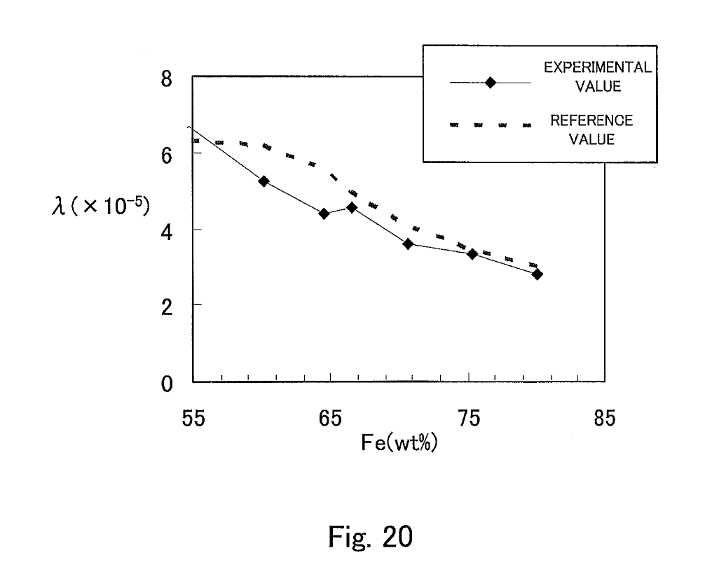

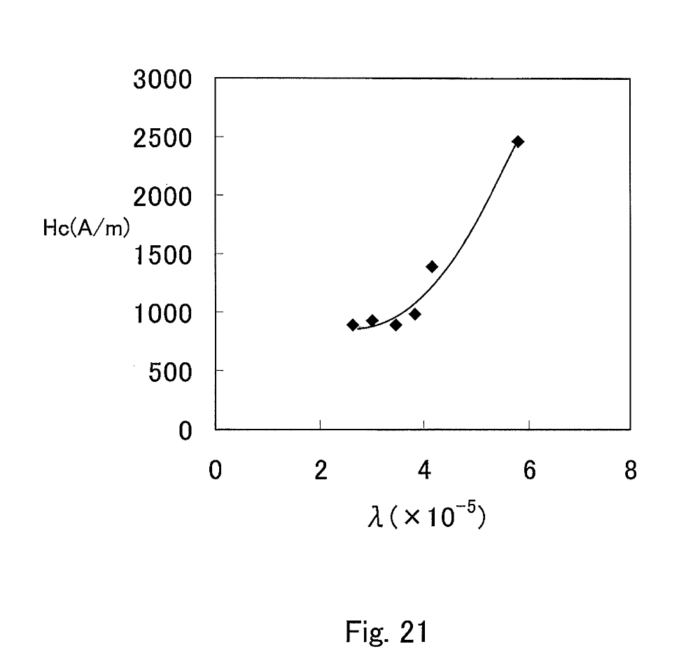

FIG. 20 is a diagram indicating the relationship between the percentage of Fe and magnetostriction λ in an FeCo alloy, and FIG. 21 is a diagram indicating the relationship between magnetostriction λ and coercivity Hc in an FeCo alloy.

It can be understood that as shown in FIG. 20, the magnetostriction λ is restrained to less than “3.5” if the percentage of Fe in the FeCo alloy is not less than 75%, and as shown in FIG. 21, the coercivity Hc can be restrained to around 800 [A/m] if the magnetostriction λ is less than “3.5”. Accordingly, it can be understood that the coercivity can be decreased while restraining the magnetostriction by providing the first magnetic layer with a composition of FeₓCo₁₀₀₋ₓ (75≦x wt %), thereby making it possible to prevent pole erasure.

Next, a sixth example will be described.

In FIGS. 16 and 17, the coercivity Hc values and the saturation magnetic flux density Bs values of a CoNiFe alloy having a composition of CoₓNi_{y}Fe_{z} (x+y+z=100, 60≦x≦80, 10≦z≦20 wt %) are plotted with crosses. It can be understood that the coercivity Hc can be effectively decreased and a high saturation magnetic flux density Bs can be provided irrespective of the first magnetic layer thickness, by using a CoNiFe alloy with a composition of CoₓNi_{y}Fe_{z} (x+y+z=100, 60≦x≦80, 10≦z≦20 wt %) as the first magnetic layer.

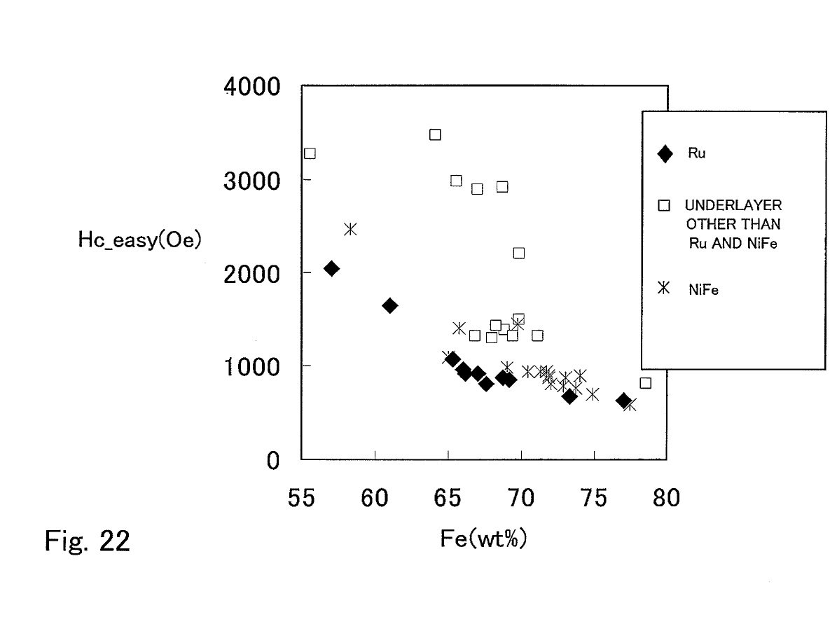

FIG. 22 is a diagram indicating the relationship between the percentage of Fe and coercivity Hc in an FeCo alloy with various underlayers.

In FIG. 22, the coercivities Hc of FeCo alloys with an underlayer of Ru are plotted with diamonds, the coercivities Hc of FeCo alloys with an underlayer of NiFe are plotted with crosses, and the coercivities Hc of FeCo alloys with an underlayer of a material other than Ru and NiFe are plotted with squares. As shown in FIG. 22, when NiFe, which is a magnetic material, or Ru, which is a non-magnetic material, is used for an underlayer and the percentage of Fe in the FeCo alloy is not less than 65%, the coercivity Hc can be restrained to 800 [A/m] or less.

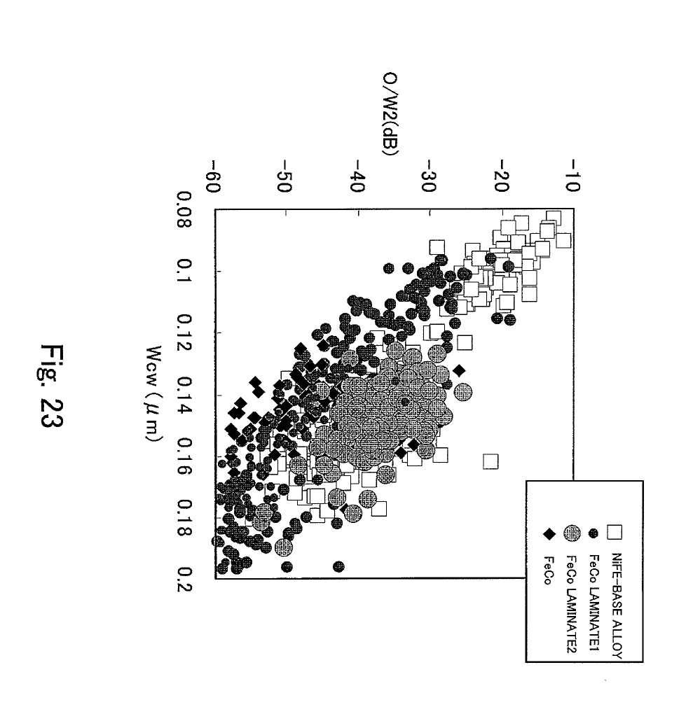

FIG. 23 is a diagram indicating the relationship between O/W performance and write core width.

In FIG. 23, the results of NiFe alloys are plotted with squares, the results of laminated layers of an NiFe alloy, which is a first magnetic layer, and an FeCo alloy, which is a second magnetic layer (here, the percentage of the cross-sectional area of the FeCo alloy exceeds 35%) are plotted with small circles, the results of laminated layers of an NiFe alloy, which is a first magnetic layer, and an FeCo alloy, which is a second magnetic layer (here, the percentage of the cross-sectional area of the FeCo alloy is 35% or less) are plotted with large circles, and the results of FeCo alloys are plotted with diamonds.

As shown in FIG. 23, it can be understood that the laminated layers the results of which are plotted with small circles (with the percentage of the cross-sectional area of the FeCo alloy exceeding 35%) has a high O/W performance, which is higher than those of the NiFe alloys and equal to those of FeCo alloys from large core width to narrow core width. Meanwhile, it can be understood that the laminated layers the results of which are plotted with large circles (the percentage of the cross-sectional area of the FeCo alloy is 35% or less) has an inferior O/W performance when compared with the FeCo alloys and the laminated layers (the percentage of the cross-sectional area of the FeCo alloy exceeds 35%) for the same core width, since many of their results are plotted above those of the FeCo alloys and the laminated layers. As describe above, it can be understood that both pole erasure prevention and a high recording density can be achieved by meeting a relationship of S2/(S1+S2)>0.35 where the area of the surface of the first magnetic layer facing a surface of the recording medium is S1, and the area of the surface of the second magnetic layer facing a surface of the recording medium is S2.

What is claimed is:

1. A magnetic head, comprising:
a magnetic pole that faces a surface of a recording medium, moves relative to the surface in a direction along the surface, and produces a line of magnetic force intersecting the surface of the recording medium; and
a coil that excites the magnetic pole, wherein
the magnetic pole includes a laminate with a coercivity of 800 A/m or less, the laminate including two or more layers stacked in a direction along the movement relative to the surface of the recording medium, the two or more layers including a first magnetic layer located at a frontmost position of the movement, and a second magnetic layer located at a rearmost position of the movement, the second magnetic layer having a saturation magnetic flux density higher than a saturation magnetic flux density of the first magnetic layer.

2. The magnetic head according to claim 1, wherein the first magnetic layer has a composition of Ni₁₀₀₋ₓFeₓ (15≦x wt %), and the second magnetic layer has a composition of FeₓCo₁₀₀₋ₓ (65≦x≦75 wt %).

3. The magnetic head according to claim 1, wherein the first magnetic layer has a composition of Ni₁₀₀₋ₓFeₓ (18≦x≦70 wt %), and the second magnetic layer has a composition of FeₓCo₁₀₀₋ₓ (65≦x≦75 wt %).

4. The magnetic head according to claim 1, wherein the first magnetic layer has a composition of CoₓNi_{y}Fe_{z} (x+y+z=100, 0<y≦10, 0<x≦33 wt %), and the second magnetic layer has a composition of FeₓCo₁₀₀₋ₓ (65≦x≦75 wt %).

5. The magnetic head according to claim 1, wherein the first magnetic layer has a composition of FeₓCo₁₀₀₋ₓ (75≦x wt %), and the second magnetic layer has a composition of FeₓCo₁₀₀₋ₓ (65≦x≦75 wt %).

6. The magnetic head according to claim 1, wherein the first magnetic layer has a composition of CoₓNi_{y}Fe_{z} (x+y+z=100, 60≦x≦80, 10≦z≦20 wt %), and the second magnetic layer has a composition of FeₓCo₁₀₀₋ₓ (65≦x≦75 wt %).

7. The magnetic head according to claim 1, wherein the first magnetic layer and the second magnetic layer of the magnetic pole are formed by plating.

8. The magnetic head according to claim 1, wherein the magnetic pole has a cross-sectional surface along the surface of the recording medium, the cross-sectional surface being narrow at a front part of the movement and being wide at a rear part of the movement.

9. The magnetic head according to claim 1, wherein the magnetic pole meets a relationship of S2/(S1+S2)>0.35 where the area of a surface of the first magnetic layer facing the surface of the recording medium is S1, and the area of a surface of the second magnetic layer facing the surface of the recording medium is S2.

10. The magnetic head according to claim 1, wherein the magnetic pole has a saturation magnetic flux density greater than 2.1 T and a coercivity lower than 800 A/m for the entire layers included in the magnetic pole.

11. The magnetic head according to claim 1, wherein the magnetic pole has a non-magnetic underlayer, and the first magnetic layer and the second magnetic layer are formed on the underlayer by plating.

12. The magnetic head according to claim 11, wherein the underlayer of the magnetic pole contains at least one kind of element from among Ru, Pd, Pt, Rh, Au, Cu, NiP, NiMo and NiCr.

13. The magnetic head according to claim 11, wherein the underlayer of the magnetic pole consists of Ru.

14. The magnetic head according to claim 11, wherein the magnetic pole has an alloy film containing at least two kinds of elements including Ni between the non-magnetic underlayer and the first magnetic layer.

15. The magnetic head according to claim 1, wherein the magnetic pole has a magnetic underlayer, and the first magnetic layer and the second magnetic layer are formed on the underlayer by plating.

16. The magnetic head according to claim 15, wherein the underlayer of the magnetic pole contains at least one kind of element from among Ni, Fe and Co.

17. An information storage device that accesses a recording medium for information storage and retrieval using a magnetic field, the information storage device comprising:
a magnetic pole that faces a surface of the recording medium and produces a line of magnetic force intersecting the surface of the recording medium;
a coil that excites the magnetic pole; and
a movement mechanism that moves the magnetic pole relative to the surface of the recording medium in a direction along the surface, wherein
the magnetic pole includes a laminate with a coercivity of 800 A/m or less, the laminate including two or more layers stacked in a direction along the movement relative to the surface of the recording medium, the two or more layers including a first magnetic layer located at a frontmost position of the movement, and a second magnetic layer located at a rearmost position of the movement, the second magnetic layer having a saturation magnetic flux density higher than a saturation magnetic flux density of the first magnetic layer.

18. The information storage device according to claim 17, wherein the first magnetic layer has a composition of Ni₁₀₀₋ₓFeₓ (15≦x wt %), and the second magnetic layer has a composition of FeₓCo₁₀₀₋ₓ (65≦x≦75 wt %).

19. The information storage device according to claim 17, wherein the first magnetic layer has a composition of CoₓNi_{y}Fe_{z} (x+y+z=100, 0<y≦10, 0<x≦33 wt %), and the second magnetic layer has a composition of FeₓCo₁₀₀₋ₓ (65≦x≦75 wt %).

20. The information storage device according to claim 17, wherein the first magnetic layer has a composition of FeₓCo₁₀₀₋ₓ (75≦x wt %), and the second magnetic layer has a composition of FeₓCo₁₀₀₋ₓ (65≦x≦75 wt %).
